(19) United States
(12) Patent Application Publication
(10) Pub. No.: US 2009/0307869 A1
(43) Pub. Date: Dec. 17, 2009

(54) CLOSING AND OPENING DEVICE OF THE SNAP TYPE FOR A MOVEABLE PART OF A PIECE OF FURNITURE

(76) Inventor: Luciano Salice, Carimate (IT)

Correspondence Address: GIFFORD, KRASS, SPRINKLE,ANDERSON & CITKOWSKI, P.C, PO BOX 7021, TROY, MI, 48007-7021, US

(21) Appl. No.: 12/440,958

(22) PCT Filed: Sep. 11, 2007
(86) PCT No.: PCT/EP07/59509

§ 371 Date: Mar. 12, 2009

(30) Foreign Application Priority Data
Dec. 9, 2006 (IT) RM2006U000162

(51) Int. Cl. E05C 19/02; E05F 5/06

(52) U.S. Cl. 16/85

(57) ABSTRACT

A magnetic fitted ratchet device assembled in rapid, safe and cost-effective manner. Advantageously, the device according to the invention is provided with suitable elastic protrusions and corresponding slots, provided on the surface of some of its components having a tubular shape, preferably cylindrical, which allow its rapid and safe assembly.

### FIELD OF THE INVENTION

The present invention refers to a closing and opening device of the snap type for a moveable part of a piece of furniture, specifically to a ratchet device.

### BACKGROUND ART

There are known ratchet devices whose function is to facilitate the opening or the closing of furniture doors or drawers, depending on the application for which they were designed. Such ratchets generate a slight contrasting force during the closing action which is accumulated by elastic elements capable of releasing it during a later step when the reverse opening operation is performed.

In case of use of a ratchet for facilitating the opening of a drawer or a door, the latter is maintained in its closing position by suitable and known devices, which may be either separated from the ratchet or integrated with it, e.g. by means of hooks, magnets or the like. In order to open the drawer or door, at first it is necessary to apply a light push to the drawer or door which releases the ratchet, which returns the elastic energy accumulated during the closing operation and exerts a force generally created by the elastic elements on the drawer in the direction of opening. An advantage of such devices is that they allow to avoid the use of handles or other similar gripping elements, which are not always welcome for reasons of appearance or other nature.

An example of these devices is that of a magnetic ratchet described in EP1598509. In such ratchet, in order to generate the rotation of the slider needed for displacing it between the inserted and extracted positions within the ratchet housing, a control device of the type used in ball-point pens is provided. Other control devices which provide a pin, fixed to the slider, whose ends follow a cam path which guides said rotation, may also be used.

Disadvantageously, in this ratchet device, closing elements are provided which must be fastened, preferably welded, to the housing for completing assembly. This operation, whose successfulness must be monitored to avoid drawbacks in use, is rather costly.

It is thus felt the need for making a closing and opening device of the snap type of a moveable part of a piece of furniture capable of overcoming the aforesaid drawbacks.

### SUMMARY OF THE INVENTION

It is the object of the present invention to make a closing and opening device of the snap type comprising a casing or an external housing such as to facilitate the assembly making it more rapid, safer and thus more cost-effective.

Therefore, the present invention suggests to reach the object mentioned above by making a closing and opening device of the snap type of a moveable part of a piece of furniture with respect to the piece of furniture itself which, in accordance with claim 1, is provided with a tubular casing having an open end and defining an internal cavity comprising components of said device, said casing comprising a distal part with respect to the open end, a proximal part with respect to said open end and a central part arranged between said distal and proximal parts, wherein the distal part is fitted onto the central part and said central part is fitted onto said proximal part.

Advantageously, the device according to the invention is very simple to assemble in virtue of the making of suitable elastic fitting protrusions and of corresponding slots, provided on the surface of the parts defining the casing of the device having an essentially tubular, preferably cylindrical, shape.

Such elastic protrusions, such as for example hooks or teeth or cotters or other suitable fitting element, may be provided either on the external or on the internal peripheral surface of these parts.

Stops delimiting the reciprocal insertion path or stroke of the corresponding parts forming the casing are advantageously provided.

The components of the opening and closing device of the invention, of the snap type such as for example of the ratchet type, comprise:

a longitudinal slider actuatable in translation in closing or opening direction, and adapted to perform a rotation about its axis at the same time as said translation,

a magnetic element arranged coaxially to the slider and suitable to make the moveable part adhere to it in closing position,

elastic means, arranged between an end of the slider and the distal part forming the bottom of the casing, adapted to exert an elastic force on the slider to make it translate in opening direction, by reacting on said bottom,

cam operating means for rotating and translating the slider.

The dependent claims describe preferred embodiments of the invention.

### BRIEF DESCRIPTION OF THE DRAWINGS

Further features and advantages of the invention will be more apparent in the light of the detailed description of a preferred, but not exclusive, embodiment, of a ratchet device illustrated by way of non-limiting example, with the aid of the accompanying drawings, in which:

FIG. 1 is a section view of a device according to the invention in extracted position;

FIG. 2 is a section view of the device in FIG. 1 in inserted position;

FIG. 3 shows a perspective view of the totally assembled device of the invention;

FIG. 4 is an exploded view of the device in FIG. 3;

FIG. 5 shows a perspective section view of a component of the device of the invention.

### DETAILED DESCRIPTION OF A PREFERRED EMBODIMENT OF THE INVENTION

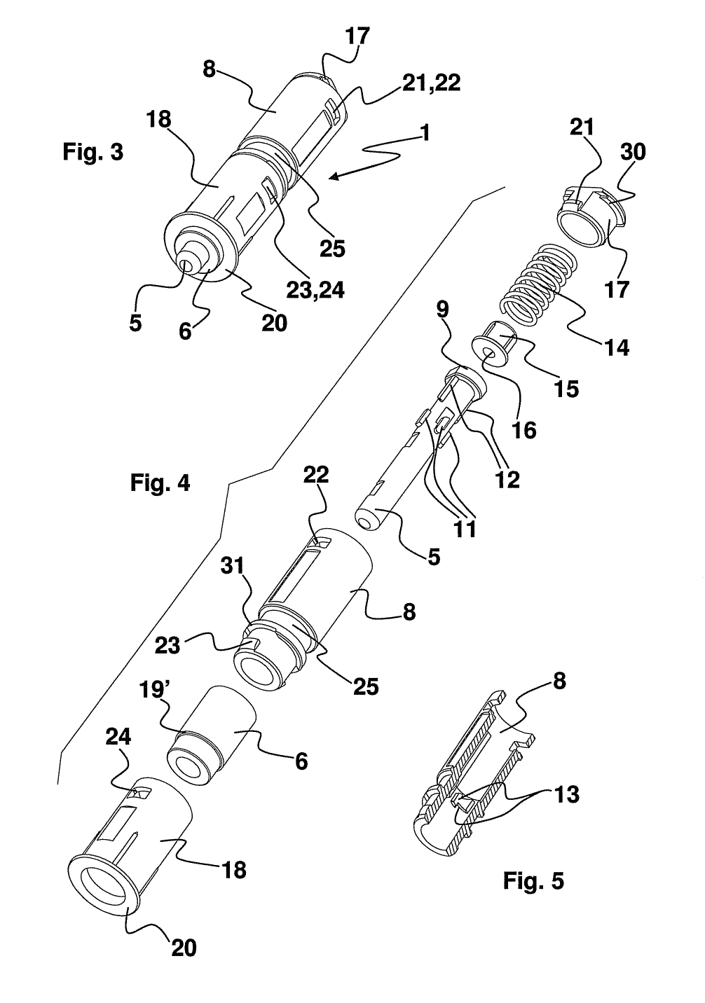

With reference to Figures from 1 to 4, it is shown a closing and opening snap device of the magnetic ratchet type, globally indicated by reference 1, which externally has a tubular shape, preferably cylindrical as better shown in FIG. 3.

Device 1 may be inserted in a suitable seat made in an adapter 2 fixed onto a wall of a piece of furniture 3, for example screwed or glued, so as to be able to interact with a moveable closing element 4, for example a furniture door or the front of a drawer.

Alternatively, device 1 may be inserted in a known manner within a blank hole obtained in the wall of piece of furniture 3 itself (not shown).

On one end of the device, slider 5 and magnetic element 6 are arranged, reciprocally coaxial and protruding from an abutting plane of the piece of furniture. Magnetic element 6 surrounds slider 5, shaped as a pin, and is free to be axially displaced for a short tract. With its front part, it may adhere to a ferromagnetic material plate 7 fixed to moveable closing element 4, so as to keep it closed.

Slider 5 may turn about its axis and slide longitudinally for a longer tract with respect to that of magnetic element 6. In its rear part, facing towards the inside of container 8, slider 5 is provided with a widened head 9 and a control or actuation device 10 of the rotation of the slider itself, needed to displace it between the inserted and extracted positions.

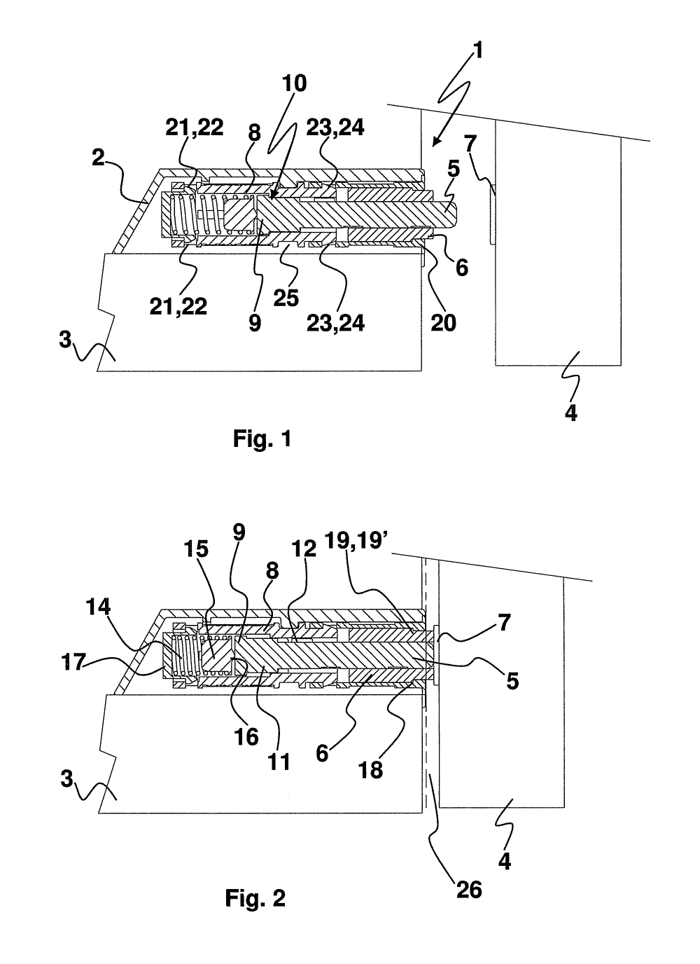

Such control device 10 is of the type used for ball-point pens. In this embodiment, it has protrusions 11, 12 located on slider 5 and provided with slanted front planes interacting with cam elements 13, visible in FIG. 5, obtained in the internal peripheral surface of container 8, such as to cause the rotation of slider 5 and its displacement between the extracted (FIG. 1) and the inserted positions (FIG. 2) under the bias of thrust spring 14. Since such device is commonly known to persons skilled in the art, it is not described in a more detailed manner.

Advantageously, spring 14 does not rest directly on slider 5 but pushes a tappet 15 provided on its frontal part with a spherical cap 16 capable of ensuring an easier rotation of slider 5. On the opposite side, spring 14 is accommodated in the central hole of a cap or bottom 17.

On the part facing moveable closing element 4, device 1 is closed by a socket 18 provided with an internal neck 19, forming a stop for a corresponding step 19′ of magnetic element 6, and an external flange 20 widened to delimit the correct assembly position of the device on the piece of furniture or on the adapter.

Advantageously, elastic teeth or hooks 21, protruding in axially opposite direction to the external surface of cap 17, of a suitable shape for a snap insertion in corresponding slots 22 arranged on the surface of container 8, are provided. Similarly, there are provided elastic teeth or hooks 23, protruding in diametrically opposite direction to the external surface of container 8, of a suitable shape for a snap insertion in corresponding slots 24 arranged on the surface of socket 18.

With reference to FIG. 4, in which the elements forming the ratchet device of the invention are shown in an exploded position, assembly is easily performed in the following manner.

Tappet 15 is inserted in the turns of spring 14, which is introduced in the central hole of cap 17. Along with slider 5, these elements are introduced within container 8 until elastic teeth 21 of cap 17 are inserted in corresponding slots 22 of container 8, preventing its disassembly. Advantageously, at least one stop 30 is provided on cap 17 adapted to delimit the stroke of body 8 during this first assembly step.

On the opposite side, magnetic element 6 is introduced in sleeve 18, which in turn is inserted on container 8 so that elastic teeth 23 of container 8 are inserted in the corresponding slots 24 of socket 18, thus completing assembly in a safe, rapid, and cost-effective manner. Advantageously, at least one further stop 31 is provided on body 8 suitable to delimit the stroke of socket 18 during this second assembly step.

In a variant (not shown), elastic teeth or hooks 21, 23 may be respectively provided on the internal surface of container 8 and on the internal surface of socket 18, and the corresponding slots 22, 24 may be respectively provided on the surface of cap 17 and on the surface of container 8.

Advantageously, the external peripheral surface of container 8 may be provided with circular grooves 25 for the assembly of the device on adapter 2. Dotted line 26 in FIG. 2 indicates the displacement of closing element 4 needed to release slider 5 from its inserted position and allow its protrusion to the extracted position in FIG. 1, in which slider 5 has detached plate 7 from magnetic element 6.

1. A closing and opening device of the snap type for a part of a piece of furniture moveable with respect to the piece of furniture itself, provided with a tubular casing, having an open end and defining an internal cavity comprising components of said device, said tubular casing comprising a distal part with respect to the open end, a proximal part with respect to said open end and a central part arranged between said distal and proximal parts, wherein the distal part is at an end partially inserted inside the central part and said central part is at an end partially inserted inside said proximal part.

2. A device according to claim 1, wherein first elastic protrusions are provided on the external surface of the distal fitting part at corresponding first slots arranged on the surface of the central part, and second elastic protrusions are provided on the external surface of the central fitting part at corresponding second slots arranged on the surface of the proximal part.

3. A device according to claim 1, wherein first elastic protrusions are provided on the internal surface of the proximal fitting part at corresponding first slots arranged on the surface of the central part, and second elastic protrusions are provided on the internal surface of the central fitting part at corresponding second slots arranged on the surface of the distal part.

4. A device according to claim 2, wherein the tubular casing has an essentially cylindrical shape.

5. A device according to claim 2, wherein said first and second protrusions are elastic teeth or cotters or hooks protruding in diametrically opposite direction on the respective surfaces.

6. A device according to claim 1, wherein the components of said device comprise:
a longitudinal slider actuatable in translation in closing or opening direction, and adapted to perform a rotation about its axis at the same time as said translation,
a magnetic element arranged coaxially to the slider and suitable to make the moveable part adhere to it in closing position,
an elastic member, arranged between an end of the slider and the distal part forming the bottom of the casing, adapted to exert an elastic force on the slider to make it translate in opening direction, by reacting on said bottom,
a cam operating member for rotating and translating the slider.

7. A device according to claim 6, wherein said cam operating member comprises further protrusions provided on the slider and provided with slanted frontal planes interacting with cam elements obtained on the internal surface of the central part of the casing, so as to cause the rotation of the slider and its translation between the opening and closing positions under the bias of the elastic member.

8. A device according to claim 7, wherein the elastic member comprises a spring accommodated in a corresponding first end in the central hole of the bottom which rests with a corresponding second end on a tappet provided on its frontal part with a spherical cap capable of ensuring an easier rotation of the slider.

9. A device according to claim 8, wherein the proximal part is a sleeve provided with an internal neck, forming a stop for a corresponding step of the magnetic element, and of an external flange widened to delimit the correct assembly position of the device on the piece of furniture or on an adapter.

10. A device according to claim 3, wherein the tubular casing has an essentially cylindrical shape.

11. A device according to claim 3, wherein said first and second protrusions are elastic teeth or cotters or hooks protruding in diametrically opposite direction on the respective surfaces.
